(19) United States
(12) Patent Application Publication
(10) Pub. No.: US 2015/0330950 A1
(43) Pub. Date: Nov. 19, 2015

(54) STRUCTURAL FATIGUE CRACK MONITORING SYSTEM AND METHOD

(71) Applicant: Eric Robert Bechhoefer, Cornwall, VT (US)

(72) Inventor: Eric Robert Bechhoefer, Cornwall, VT (US)

(21) Appl. No.: 14/712,598

(22) Filed: May 14, 2015

Related U.S. Application Data
(60) Provisional application No. 61/994,206, filed on May 16, 2014.

(51) Int. Cl. G01N 29/14

(52) U.S. Cl. CPC G01N 29/14; G01N 2291/044

(57) ABSTRACT

A monitoring system of the present disclosure reduces the sampling and processing requirements for on-line/in-flight monitoring of structural components and thus facilitates detection of high cycle/low amplitude fatigue damage. Moreover, the monitoring system can develop a physical failure model based on information received from monitoring sensors that can be used to determine the remaining useful life (RUL) of structural components. In an exemplary embodiment, the incorporation of low cost, light weight, bused sensors would facilitate in-flight load tracking and detection of high cycle/low amplitude fatigue damage. In this embodiment, a model based on the physical degradation process of the material under analysis (e.g., a physical failure model based on cumulative damage estimation, i.e., based on an AE events count) can be generated using measurable and quantifiable parameters from these sensors and accordingly the RUL of structural components can be determined.

### RELATED APPLICATION DATA

This application claims the benefit of U.S. Provisional Application Ser. No. 61/994,206, filed May 16, 2014, entitled “Structural Fatigue Crack Monitoring System and Method” which is hereby incorporated by reference herein in its entirety.

### FIELD OF THE INVENTION

The present invention generally relates to structural monitoring systems for materials under high cyclic loads. In particular, the present invention is directed to a Structural Fatigue Crack Monitoring System and Method.

### BACKGROUND

Many structural components experience cyclic loads and corrosive environments that contribute to damage to the components. Examples of these structural components include, but are not limited to, pipes, bridges, and aircraft.

Aircraft, particularly rotorcraft (e.g., helicopters), operate in an environment that includes harsh loading conditions and corrosive elements, both of which factor into the accumulation of structural damage on rotorcraft components. The design life of structural components for these aircraft has been developed using a “safe-life” approach. Under this approach, structural component life is determined using S-N curves (also known as a Wohler curve), where loads are developed from a nominal mission spectrum. The drawbacks of this design philosophy include: components must be replaced after the design life has expired even though they may still have considerable useful life left with high reliability; the actual mission loads for any aircraft may be different than the design spectrum, e.g., where heavily used aircraft (repeated hot and heavy lifts) may have consumed component life faster than the aircraft flight time would indicate leading to a reduction in the safety margin; and the component is compromised by corrosion, improper maintenance, or the manufacturing process, such that the component is operating at a reduced safety margin.

These issues suggest the need for an innovative solution to accurately determine the current component health/accumulated fatigue damage in order to maximize the utility of the components while maintaining design safety margins.

### SUMMARY OF THE DISCLOSURE

In a first exemplary aspect a . . . .

In another exemplary aspect a . . . .

In yet another exemplary aspect a . . . .

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a pair of charts showing data captured by prior art acoustic emission (AE) systems;

FIG. 2 is a block diagram of an exemplary monitoring system according to an embodiment of the present invention;

FIG. 3 is an illustration of a helicopter including a monitoring system according to an embodiment of the present invention;

FIG. 4 is a representation of a Hilbert transform circuit according to an embodiment of the present invention;

FIG. 5 is a block diagram of an exemplary process for determining the remaining useful life (RUL) of a component under high cyclic load according to an embodiment of the present invention;

FIG. 6 shows a system and its full state KF according to an embodiment of the present invention; and

FIG. 7 is a block diagram of a computing system suitable for use with a monitoring system according to an embodiment of the present invention.

### DESCRIPTION OF THE DISCLOSURE

The U.S. Navy and Army aviation groups have integrated Health and Usage Monitoring Systems (HUMS) into their rotorcraft maintenance schemes with the intent of moving from time-based maintenance to an “on condition” based maintenance paradigm. To that end, these groups have looked to include Prognostic Health Management (PHM) capabilities, which allows for estimates of remaining useful life (RUL) of rotorcraft components. The promise of HUMS with PHM is to produce maintenance savings by reducing unscheduled maintenance events. And, as confidence in PHM improves and systems mature, maintenance paradigms can be moved to a true, “on condition” practices. The potential impact of PHM on deployable assets (e.g., rotorcraft) will be profound, including benefits such as the operator being able to ship spares when needed instead of holding spares in stock, and the operator can choose the best helicopter to deploy for any given mission, so the “healthiest” aircraft are sent if maintenance is not easily performed.

Unfortunately, PHM designs have not proven successful in rotorcraft or fixed wing-application because a number of technical hurdles have limited the application of structural health monitoring (SHM) to HUMS or PHM, with one of the largest hurdles being the detection/feature extraction of a damage event from the collected monitoring information. The deficiencies in fatigue monitoring can be overcome by using the structural fatigue crack monitoring system and method (the “monitoring system”) as discussed herein.

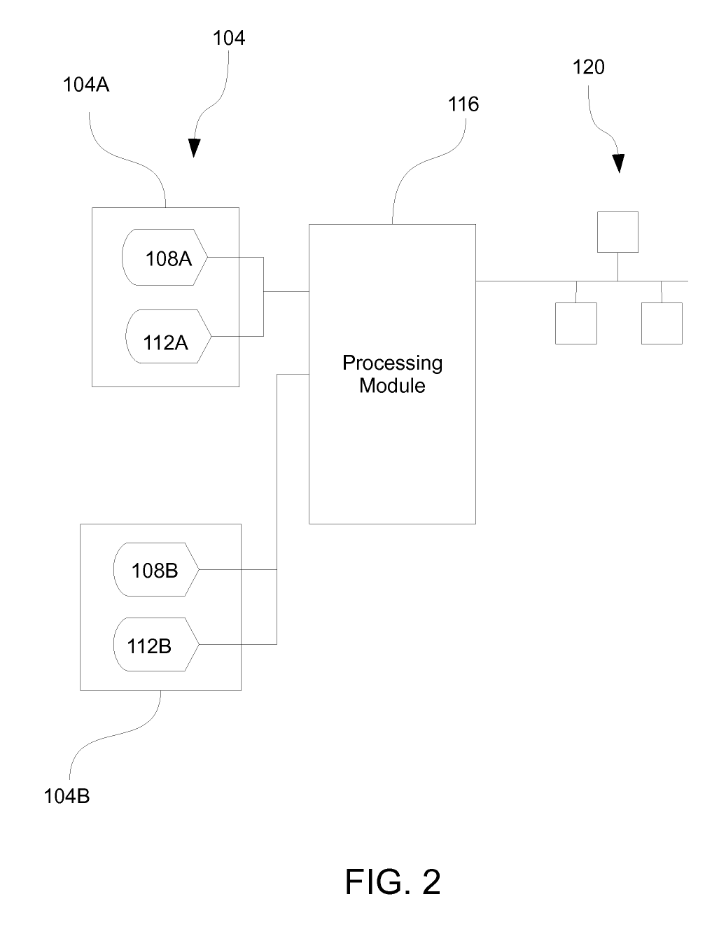

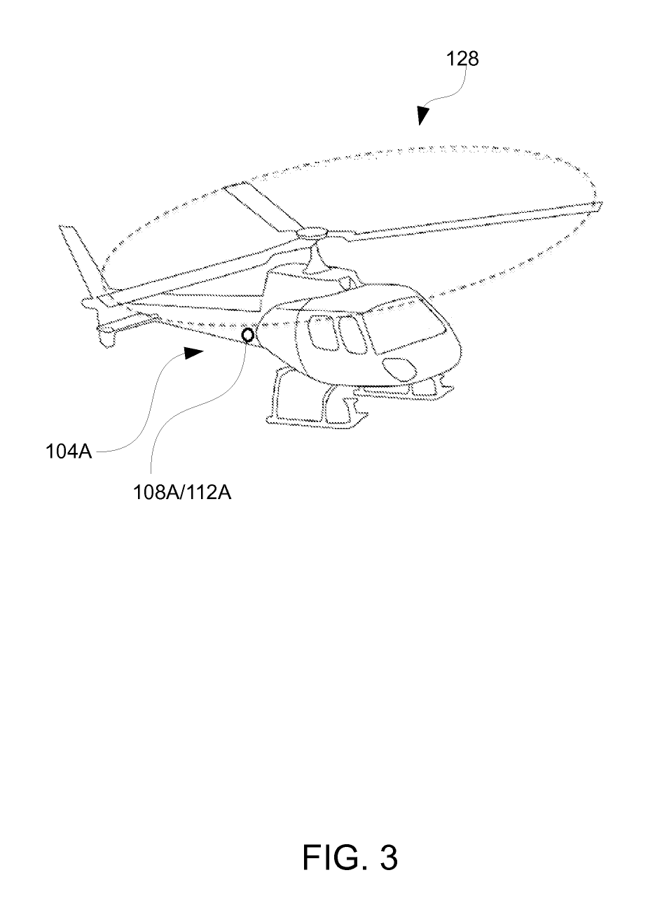

Turning to FIGS. 2 and 3, at a high level, a monitoring system according to the present disclosure, such as monitoring system 100 (FIG. 2), includes a plurality of sensors 104 gathering information about the structural component under observation (FIG. 3 shows a tail boom of a helicopter including sensors 104). For each structural component under observation, monitoring system 100 includes at least a pair of sensors 104 (two pairs shown in FIG. 2) with at least one thermodynamic sensor 108 (e.g., 108A and 108B) measuring thermodynamic entropy and at least one acoustic emission (AE) sensor 112 (e.g., 112A and 112B) capturing acoustic emission information from the structural component. This information is provided to a processing module 116, which records the information from sensors 104 and can analyze the data. In another exemplary embodiment, processing module stores the information in one or more databases 120 for analyzing by maintenance operators after the end of the rotorcraft flight or when it is desired to evaluate the component under cyclic load.

From the information collected from sensors 104, a physical failure model can be deduced for the structural component under evaluation and consequently, a RUL.

Before providing additional details regarding monitoring system 100, a brief discussion of AEs is provided.

Acoustic Emissions

AEs are the stress waves produced by the sudden internal stress redistribution of material caused by the changes in the internal structure of the material. Possible causes of these changes are crack initiation and growth, crack opening and closure, or pitting in various monolithic materials (gear, bearing material) or composite materials (concrete, fiberglass). Most sources of AE are damage related. Thus, the ability to detect AEs can be used to give diagnostic indications of component health.

AE as a phenomenon has been observed in many disparate fields of study. One of the earliest uses of AE analysis was in geology and seismology, where the analysis of elastic waves produced by an earthquake was used to find the location and depth of the event. Similarly, AE has been proposed as a method to predict rockburst in mines, tinsmiths have noted the “tin cry” associated with twinning deformation, and the clicks noted during heat treatment of steels is well documented.

AE is associated with dislocation and plastic deformation/crack propagation in metal. The essential principles of AE where explored in Liptai, R. G., Dunegan, H. L., and Tatro, C. A. “Acoustic Emissions Generated During Phase Transformation in Metals and Alloys,” Int. J. Nondestruct. Test. 1, 213 (1969), by considering a grain of polycrystalline material (steel, for example), where the grain boundary has a diameter of 5×10̂-3 in. During a strain event, the upper half of the grain slips over the lower half by a distance of 1×10̂-3 in. Given a shear modulus for steel of 4×10̂6 psi, then the stress driving the deformation determined using Equation 1, and the energy change occurring with a deformation is available from Equation 2.

$$\begin{matrix}{σ}_{s} = sG / d & ( Equation 1 ) \\ Δ E = {s}^{2} GA / 2 d = {10}^{- 12} in / lbs & ( Equation 2 )\end{matrix}$$

Where:
σₛ=deformation stress
s=slip distance
G=shear modulus
d=grain boundary diameter
A=shear area
ΔE=energy change associated with deformation

Equations 1 and 2 allow for an estimate of the frequency of a slip event using Equation 3:

$$ω = \sqrt{2 GA / d m} \approx 5 \times {10}^{6} rad / sec \approx 0.8 MHz \qquad ( Equation 3 )$$

Where:
ω=AE frequency
m=half mass of the grain.

AE frequency estimates vary with density, grain size, and material; however, the estimate provided by Equation 3 bounds the AE frequency from about 500 KHz to perhaps about 40 MHz.

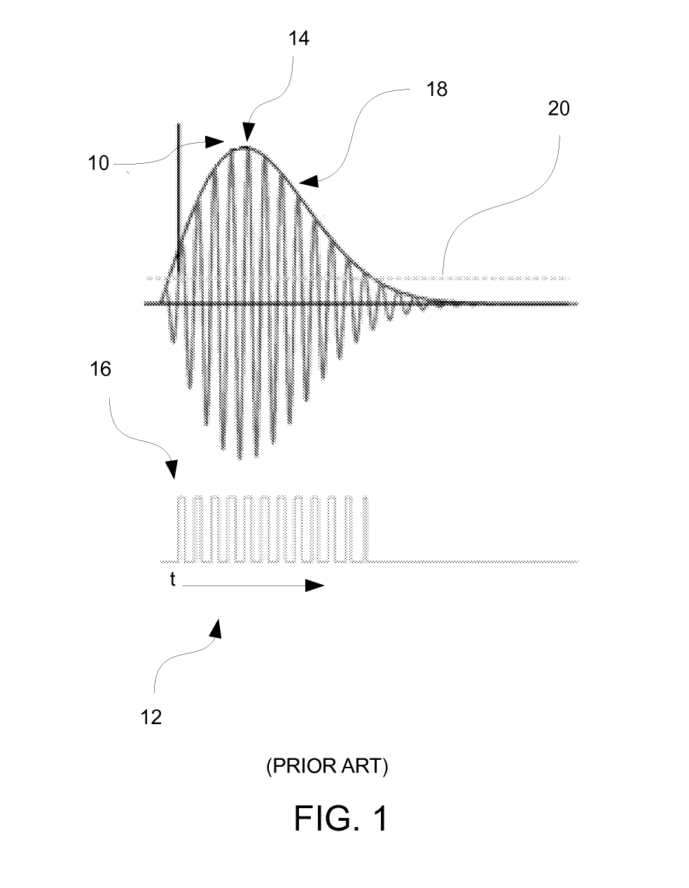

It should be noted that AE frequency is a direct measure of damage instead of an indicator of the result of damage (such as vibration) and can therefore be a reliable indicator of a damage event. However, AE detection and measurement systems tend to be expensive and difficult to implement. Prior art AE measurement devices generally capture five basic condition indicators, as depicted in FIG. 1: Amplitude 10, Duration 12, Rise Time 14, Counts 16, and the mean area under the rectified signal envelope (MARSE) 18; and develop a threshold value, 20. Other condition indicators, such as average frequency (i.e., counts/time), are a function of the aforementioned measurements, with cumulative counts and cumulative absolute energy being correlatable to the fatigue crack growth process. From a development perspective, AE measurement systems have a number of system level challenges: (1) AE signals are relatively high frequency, 1 to 4 MHz, thus the sample rates are typically high (4 to 10 million samples per second (MSPS)); (2) processing of the data is difficult because of the high sample rates and large volume of data that needs to be processed (consider 10 MSPS for 1 minute of continuous SHM, which would capture 600 million samples); and (3) distilling the AE event associated with component fatigue/failure from the received information, information that includes a white noise signal, presents significant challenges. Accordingly, while successful collection and analysis of AE data for rotorcraft and fixed-wing aircraft needs to be continuous and processed in real-time, but the solution has proved elusive.

### Monitoring System

A monitoring system of the present disclosure reduces the sampling and processing requirements for on-line/in-flight monitoring of structural components and thus facilitates detection of high cycle/low amplitude fatigue damage. Moreover, the monitoring system can develop a physical failure model based on information received from monitoring sensors (e.g., sensors 104) that can be used to determine the RUL of structural components. In an exemplary embodiment, the incorporation of low cost, light weight, bused sensors for SHM into a HUMS (or PHM system) would facilitate in-flight load tracking and detection of high cycle/low amplitude fatigue damage. In this embodiment, a model based on the physical degradation process of the material under analysis (e.g., a physical failure model based on cumulative damage estimation, i.e., based on an AE events count) can be generated using measurable and quantifiable parameters from these sensors and accordingly the RUL of structural components can be determined.

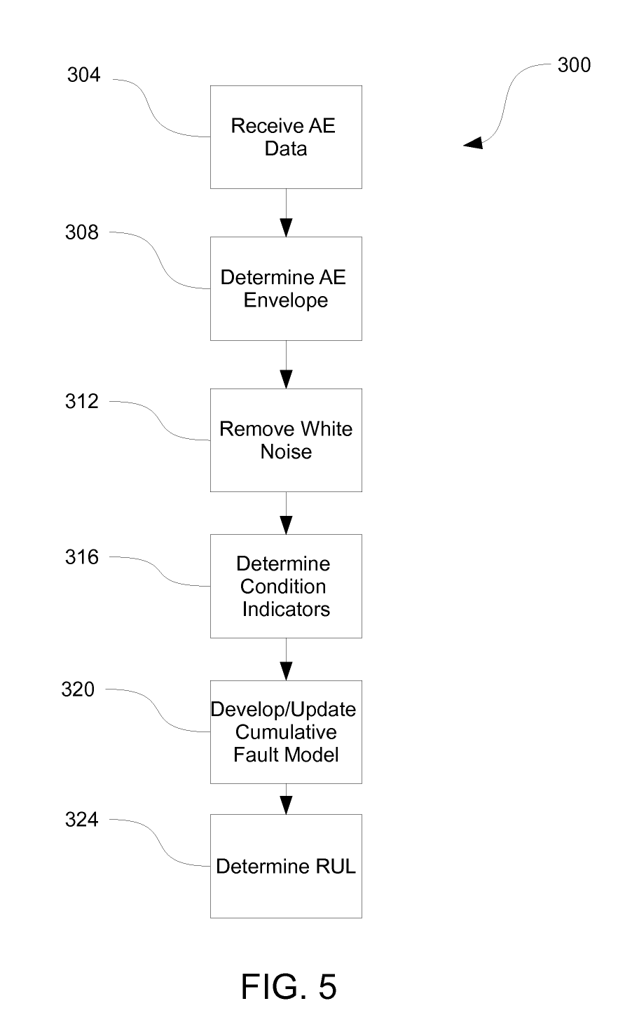

Returning now to FIGS. 2 and 3 and with further reference to FIG. 5, which shows an exemplary process of determining RUL 300, in an exemplary embodiment, monitoring system 100 acquires AE data (step 304), via for example, AE sensor 112A, representative of a one or more AE dislocation events, and collects thermodynamic entropy data, via for example, thermodynamic sensor 108A, representative of crack propagation. The information gathered by sensors 104 is sent to processing module 116, which can determine an AE threshold (discussed in more detail below) from the data and also determines a count of the number of AE dislocation events to determine cumulative counts over time and the rate of arrival of counts. Processing module 116 can also process the thermodynamic entropy data, in combination with the processed AE data, so as to determine RUL. Thermodynamic entropy data (relative heat rise) is associated with low cycle fatigue, which is indicative of severe damage accumulation.

As discussed above, an AE is generated by an impulse or forcing function that causes a dislocation in the structure or component. For example, and with reference to FIG. 3, a helicopter 128 with sensors 104 located on its tail boom can be monitored for structural damage occurring during various helicopter activities. If a crack in the material of tail boom, due to stresses exerted thereon, begins to propagate it will provide AE. For high cycle loads, the force and the resulting damage would be associated with aircraft regime (e.g., a maneuver). Accordingly, the AE waveform is effectively a carrier signal on which the forcing function is modulated, with the forcing function information relating to the damage that it is exciting (e.g., the AE). For a nominal structure with a benign load, there should be no AE signal, while a damaged structure under high cycle fatigue load should generate an AE response when under force.

In the fault case, the information of interest is not the AE data itself, but the modulated force/load that is causing the AE (i.e., the envelop energy generated during the AE). In monitoring system 100, the incoming AE data is demodulated with an analog circuit, e.g., an analog Hilbert transform circuit, resulting in acoustic processing frequencies (e.g., 40 KHz), which can be processed with low cost embedded microcontrollers.

A demodulator shifts the carrier frequency to baseband, which is followed by low pass filtering and enveloping. The baseband signal (the band of frequencies from close to 0 hertz up to a higher cut-off frequency or maximum bandwidth) is determined using Equation 4, below:

cos(a)×cos(b)=½[cos(a−b)+cos(a+b)] (Equation 4)

The envelope of the AE sensor data is determined at step 308 of process 300 and contains the information related to load causing fatigue. The envelope is calculated by taking the absolute value of the low pass filtered Hilbert transform (the image cos(a+b) of Equation 4 is removed via low pass filtering). The process of convolving one frequency a, with another frequency b, and low pass filtering is a heterodyne. In the frequency domain, the Hilbert transform is defined in the Fourier domain as: 2*X(f), for f>0, and X(f)=0, for f<0, which can be determined and requires little computational load. The use of an analog circuit allows these computations to be executed without the need of a microcontroller or digital signal processing unit.

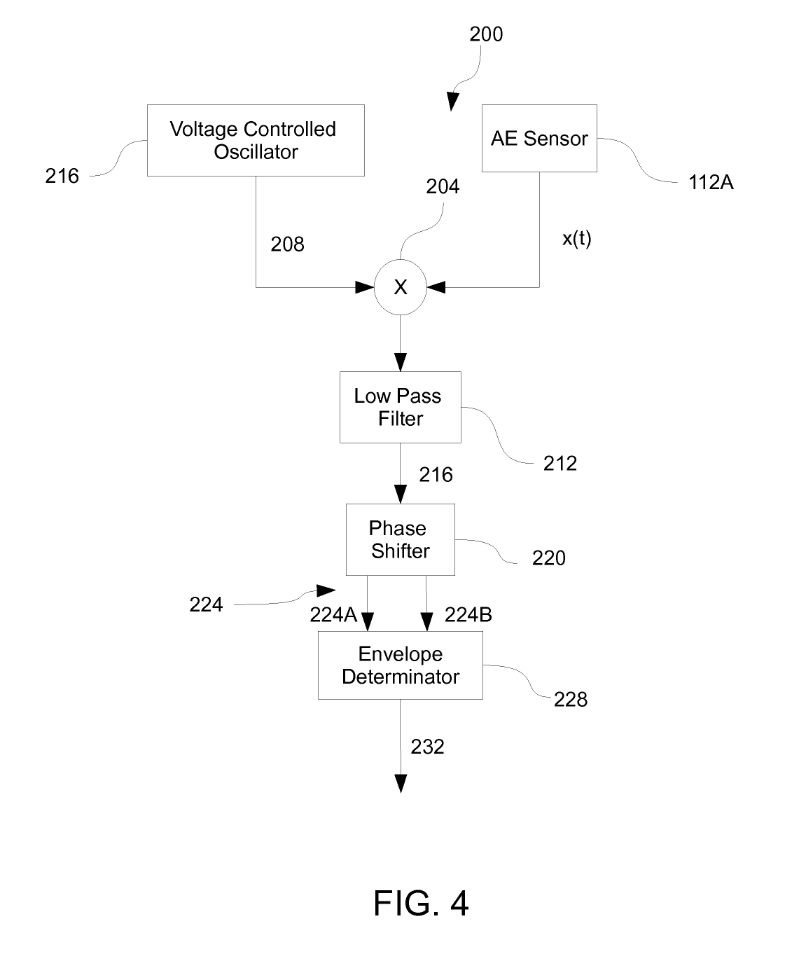

An exemplary demodulating circuit 200 for determining an AE envelope is shown in FIG. 4. As shown, the raw, time domain signal from the AE sensor (as shown, AE sensor 112A), x(t), is quadrature demodulated by convolver 204, which convolves the signal x(t) with a frequency near the carrier frequency 208, (cos(ft)), which is then sent to a low pass filter 212 to remove the image (e.g., cos (a+b)), thereby producing an output signal 216. Phase shifter 220 then generates a pair of quadrature signals 224 (e.g., signals 224A and 224B) are generated by shifting output signal 216 by n/2 radian. Quadrature signals 224 are then squared, summed, and the square root at envelope determinator 228 so as to produce an envelope 232, which defines the envelope of the AE data. For a structural component, e.g., a gearbox support frame, or tail boom (see FIG. 3), where the load is a function of an aircraft maneuver, the envelope of the AE sensor data would contain the information related to load causing fatigue.

The carrier frequency can be generated by a voltage-controlled oscillator (VCO) 216 or by low pass filtering a pulse width modulated (PWM) signal (not shown). The demodulating process via demodulating circuit 200 allows for demodulation of different materials (which may have different AE carrier frequencies) or for different AE sensors, which may have different frequency responses. This circuit can be built at low cost using operational amplifiers or by using a monolithic multiplier/divider such as the pretrimmed single chip monolithic multiplier/divider offered by Analog Devices, Inc. of Norwood, Mass.

An advantage of using an analog/hardware solution is the acquisition and processing system. Thus, instead of designing a system to sample AE at potentially 10 MSPS (which includes increased memory, a high performance processor, a high speed analog-to-digital converter (ADC), increased capacity of the power supply, and increased heat dissipation), a more modest system can be designed, for example, but not limited to, a 20 to 100 thousand samples per second (KSPS) system. Advantageously, with the aforementioned design, the limits of the system are no longer the sample rate of the ADC, but the bandwidth of the analog devices, which is typically on the order of 2 GHz.

An ADC suitable for use with a monitoring system discussed herein would preferably use a Delta-Sigma architecture, which allows changing the sample rate and effective sensor bandwidth without the use of an anti-aliasing filter network. Generally, a Delta-Sigma ADC uses oversampled input signals and a finite impulse response (FIR) filter to eliminate aliasing, which reduces the complexity of the AE sensor. An ADC suitable for use with the monitoring system described herein would a 24-bit, delta-sigma analog-to-digital converter from Texas Instruments, Inc. of Dallas, Tex.

Detecting an AE event from the information collected from the AE sensor is accomplished by removing a white noise signal from the information at step 312. It can be shown that the energy associated with the envelope of a white noise signal can be modeled as: Real quadrature, X=N(0, σ), Imaginary quadrature, Y=N(0, σ), and the envelope energy is: E=\sqrt{X²+Y²}. Using the methods of moments, it can be shown that the distribution of E is a Rayleigh distribution. Energy that is not associated with a white noise process, e.g., a real AE event due to dislocation (which is associated with the accumulation of damage), is greater than the measured random noise process. The threshold for the white noise process can be found by using the inverse Rayleigh CDF, using an appropriate probability of false alarm (PFA), e.g., 1e-5, and β in association with Equation 5:

β=σ_{E}/\sqrt{2−π/2} (Equation 5)

where σ_{E} is the standard deviation of the measured energy.

The above described equation allows for detection of an AE event and the discarding of signals associated with nominal white noise. During the real time monitoring of the baseband signal (x(t)), when energy is detected above the threshold, it is either an AE event due to cyclic loading or a false alarm. In an exemplary embodiment, a threshold value is set such that in a nominal noise process, the probability of false alarm (PFA) is on the order of 1 e-6. Due to this threshold value, a false alarm, by definition, is rare.

At step 316 condition indicators, that are representative of the health of the structure under evaluation, can be developed based on the AE events. These condition indicators can include, but are not limited to, the magnitude of the AE event, the cumulative number of AE events, and the operational time from the last AE event. These condition indicators (parametric values) can be used, in conjunction with the cumulative fault model discussed below, to estimate the total damage of the structure and to estimate the remaining useful life (RUL). Further understanding of the RUL can be found by determining a cumulative fault model (CFM) based upon one or more condition indicators.

As discussed above, the fatigue process is accompanied by a transformation of energy, which can include both AE (as discussed above) and thermodynamic entropy. Thermodynamic entropy is correlated with the plastic zone ahead of a crack tip and the derived correlation for plastic energy dissipation is Paris' law. Thus, development of the CFM, at step 320, according to an embodiment of the present disclosure, begins with Paris' Law, which governs the rate of crack growth in a homogenous material:

da/dN=D(ΔK)^{m} (Equation 6)

Where:
da/dN is the rate of change of the half crack length
D is a material constant of the crack growth equation
ΔK is the range of strain K during a fatigue cycle
m is the exponent of the crack growth equation

The range of strain, ΔK is given as:

ΔK=2σα(πa)^{1/2} (Equation 7)

Where:
σ is gross strain
α is a geometric correction factor
a is the half crack length

The variables in Equation 7 are specific to a given material and/or article under monitoring (such as a tail boom assembly, structural bulkhead, or load bearing frame). In practice, the variables are unknown, which therefore necessitates some simplifying to facilitate analysis. For example, for many components/materials, the crack growth exponent is 2 and the geometric correction factor α can be set to 1, which allows Equation 7 to be reduced to:

da/dN=D(4σ²πa) (Equation 8)

At step 324 the RUL is determined by determining the number of cycles, N, from the current measured crack aₒ to the final crack length a_{f}.

In order to determine N, the reciprocal of Equation 8 (shown as Equation 9) is integrated (shown below in Equation 10). The reciprocal of Equation 8 is:

$$d N / d a = 1 / D ( 4 {σ}^{2} π a ) \qquad ( Equation 9 )$$

The measured component condition indicator, such as the time of arrival between AE events, can be used as a surrogate for rate of change in cycles over time, from which an estimate of crack length a can be derived. Given a suitable threshold set for a_{f} (which can be set either statically or set based on an allowable crack length of the structure under monitoring) then N is the RUL times a constant (RPM for a synchronous system). (Note that N, for synchronous systems (e.g., constant RPM), can be equivalent to time by multiplying N by a constant.)

Thus, N is equal to:

$$\begin{matrix}N = {\int }_{{a}_{o}}^{{a}_{f}} d N / d a \\ = \int 1 / D ( 4 {σ}^{2} π a ) d a \\ = 1 / D ( 4 {σ}^{2} π ) ( ln ( {a}_{f} ) - ln ( {a}_{o} ) )\end{matrix} \qquad ( Equation 10 )$$

Where the material crack constant, D, is estimated as:

D=da/dN/(4σ²πa) (Equation 11)

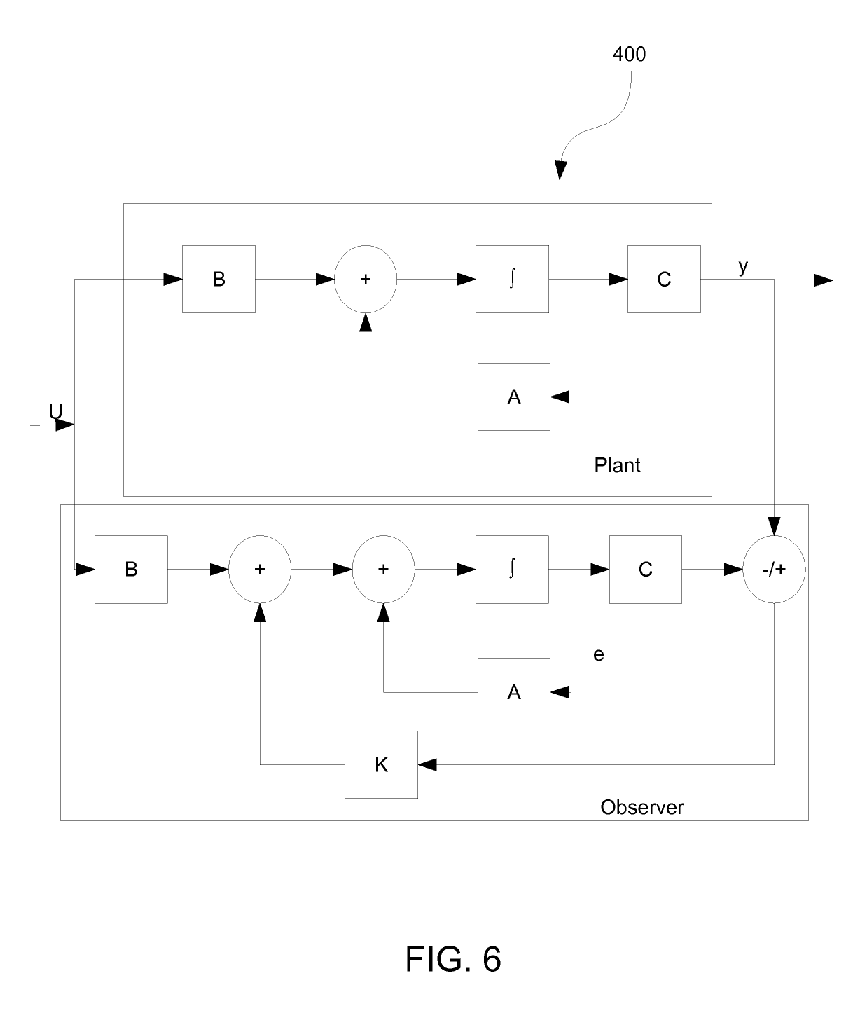

While in practice gross strain will not be known, the cumulative number of AE counts can be assumed to be proportional to crack length, the range of strain ΔK is proportional to the maximum of the AE envelope value (a CI derived and shown in FIG. 6), which allows for the inference that the maximum value of the envelope is also a function of crack length), and the temperature rise due to plastic deformation effects can be modeled as the exponent of the crack growth equation, m (found in Equation 6), see M Amir, M. Khonsari, “On the Role of Entropy Generation in Processes Involving Fatigue”, Entropy 2012, 14, 24-31.

For Paris' Law to be used for RUL estimation, a determination of the unknown coefficients of Paris' Law, specifically, the material crack constant, D, must be made. In an exemplary embodiment, D can be estimated using one or more state space models, such as the one shown in FIG. 6. A state space model is a technique that allows one to reconstruct unknown variables from the use of an appropriate model, such as Equation 6. The choice of which type of state space technique to use is driven by the nature of the system dynamics and the noise source. For example, for a linear dynamic system with Gaussian noise, a Kalman filter (KF) is typically used. Alternatively, if it is a non-linear process, with Guassian noise, a sigma-point Bayesian process (e.g., unscented Kalman filter—UKF) or extended Kalman filter (EKF) is likely appropriate. Lastly, for non-linear dynamic systems with non-linear noise, a sequential Monte Carlo method employing sequential estimation of the probability distribution using “importance sampling” techniques is typically used.

The linear dynamics and Gaussian noise allows us to descript the state space model using a Kalman filter. The Kalman filter estimates the unknown state variable on the basis of measurement of the output and input control variables. In general, a system plant (in this case, the crack propagation model) can be defined by Equations 12 and 13:

\dot{x}=Ax+Bu (Equation 12)

y=Cx (Equation 13)

Where:
x is the state variable
\dot{x} is the rate of change of the state variable
y is the output of the system.

A KF is a subsystem used to reconstruct the state space of the plant (and is discussed in more detail below). The model of the KF is the same as that of the plant, except that an additional term is added to include the estimated error, which accounts for inaccuracies of the A and B matrixes. Effectively, any hidden state (such as RUL) can be successfully reconstructed through the plant model (e.g., crack propagation model). KF is defined by Equation 14 as:

{dot over (\hat{x}=A\hat{x}+Bu+K(y−C\hat{x}) (Equation 14)
Where:
{dot over (\hat{x} is the estimate state
C\hat{x} is the estimated output

The matrix K is the Kalman gain matrix (linear, Gaussian case) and is a weighting matrix that maps the differences between the measured output y and the estimated output C\hat{x}. A KF can be used to optimally set the Kalman gain matrix.

FIG. 6 represents a system and its full state KF 400 according to an embodiment of the present disclosure.

A KF is a recursive algorithm that optimally filters the measured state based on a priori information such as the measurement noise, the unknown behavior of the state, the relationship between the input and output states (e.g., the plant), and the time between measurements. The algorithm can be designed with no matrix inversion and as a one step, iterative process. Thus, for example, the filtering process can be understood as:

### State Prediction

| | |
|---|---|
| Xt\|t − 1 = A Xt − 1\|t − 1 | State |
| Pt\|t − 1 = A Pt − 1\|t − 1A′ + Q | Covariance |
| K = Pt\|t − 1 C′ [C Pt\|t − 1 C′ + R] − 1 | Gain |
| Pt\|t = (I − KC) Pt\|t − 1 | State Covariance |
| X t\|t = Xt\|t − 1 + K(Y − C Xt\|t − 1) | State Update |

Where:

| | |
|---|---|
| t\|t − 1 | is the condition statement (e.g. t given the information at t − 1) |
| X | is the state information (x, xdot, x dot dot) |
| A | is the state transition matrix |
| Y | is the measured data |
| K | is the Kalman Gain |
| P | is the state covariance matrix |
| Q | is the process noise model |
| C | is the measurement matrix |
| R | is the measurement variance |

For nonlinear systems with Gaussian noise (UKF or EKF), the state prediction is a function of Xt−1|t−1, and A. In this example, C is the Jacobian (e.g. the derivative of the state with respect to the measurement).

For non-linear, non-Gaussian noise problems, particle filters (PF) are attractive. PF is based on representing the filtering distribution as a set of particles. The particles are generated using sequential importance re-sampling (a Monte Carlo technique), where a proposed distribution is used to approximate a posterior distribution by appropriate weighting. An important consideration for Monte Carlo methods (such as PF) is that it requires an estimate of the posterior distribution using sample based simulation. Starting with Bayes rules in Equation 15:

$$Pr ( X \vert Y ) = Pr ( Y \vert X ) * Pr ( X ) / Pr ( Y ) \qquad ( Equation 15 )$$

Where:
   X is the distribution of the measurement
   Y is the resampled distribution

Performance of the model is heavily conditioned on the selection of measurement probability distribution function (PDF) (distribution, first and second moment). However, this estimation of X for the linear (KF) and non-linear (EKF) case assists in determining R, the measurement noise model.

Typically, the best estimate for the first moment is the state-space model itself. Thus, it can be assumed that one of the states of interest is the expected value of the measurement. While some have assumed a constant value for the second moment (variance: σ²); this is a poor assumption because measured energy is modeled by a Rayleigh PDF. The Rayleigh PDF is unusual because the mean is proportional to variance by: σ̂2=(4π−1)μ̂2, which indicates that as the mean energy increases due to damage, the variance increases by the mean squared. To address this, an accessory calculation of variance should be made using the recursive estimate available from Equation 16:

σₜ²=(1−a)σₜ₋₁²+(CE[X_{t|t-1}|Yₜ₋₁]−Y)² (Equation 16)

Equation 16 is one realization of an Infinite Impulse Response (IIR) filter. Techniques for determining the filter coefficients, such as employing Butterworth filter design method and a normalized bandwidth of 0.1, result in the crack length filter coefficient, a, being determined as 0.2677.

In use, the total cycle counts until it is appropriate to do maintenance, N, is based on the point at which the crack length, a, exceeds some level at which the reliability of the component is compromised. N is therefore representative of a high cycle fatigue value, given: the lack of knowledge in the relationship between crack length and any AE event or temperature signal; the range of strain, ΔK, is a function of a and strain, which is assumed to be proportional to AE event magnitude; and that by taking the expectation of the arrival rate of a count, the RUL in cycles (N), can be calculated as flight time.

In an exemplary embodiment, a statistical method can be used to set the threshold for a, such as those methods used in vibration health monitoring.

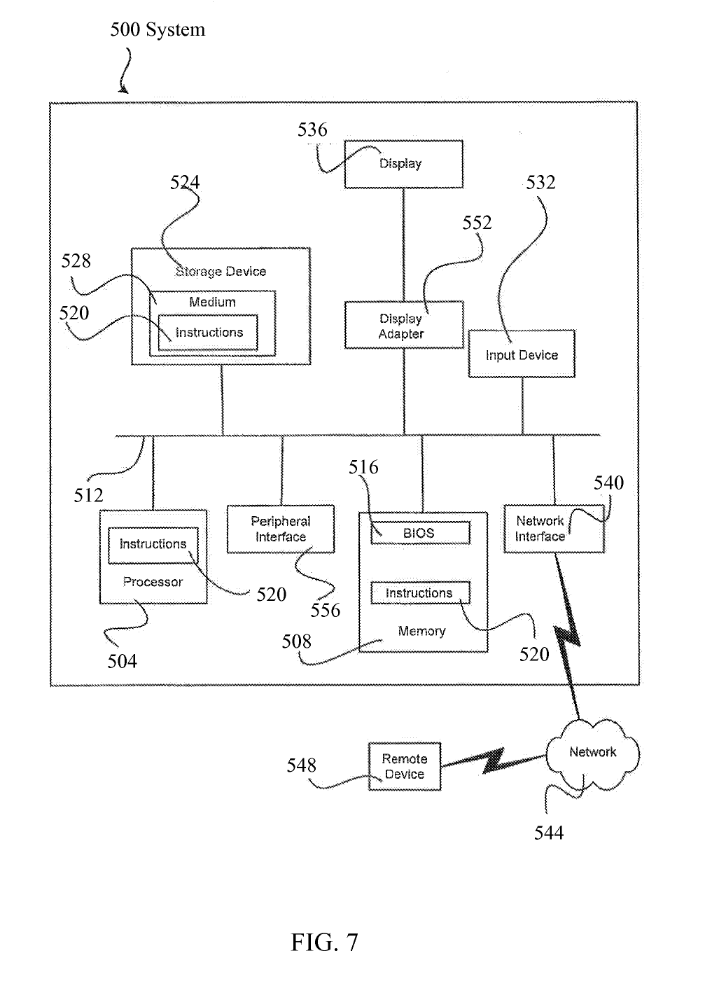

FIG. 7 shows a diagrammatic representation of one embodiment of a computing device in the exemplary form of a computer system 500 within which a set of instructions for causing a control system, such as monitoring system 100 of FIG. 2, to perform any one or more of the aspects and/or methodologies of the present disclosure may be executed. It is also contemplated that multiple computing devices may be utilized to implement a specially configured set of instructions for causing the device to perform any one or more of the aspects and/or methodologies of the present disclosure. Computer system 500 includes a processor 504 and a memory 508 that communicate with each other, and with other components, via a bus 512. Bus 512 may include any of several types of bus structures including, but not limited to, a memory bus, a memory controller, a peripheral bus, a local bus, and any combinations thereof, using any of a variety of bus architectures.

Memory 508 may include various components (e.g., machine readable media) including, but not limited to, a random access memory component (e.g., a static RAM “SRAM”, a dynamic RAM “DRAM”, etc.), a read only component, and any combinations thereof. In one example, a basic input/output system 516 (BIOS), including basic routines that help to transfer information between elements within computer system 500, such as during start-up, may be stored in memory 508. Memory 508 may also include (e.g., stored on one or more machine-readable media) instructions (e.g., software) 520 embodying any one or more of the aspects and/or methodologies of the present disclosure. In another example, memory 508 may further include any number of program modules including, but not limited to, an operating system, one or more application programs, other program modules, program data, and any combinations thereof

Computer system 500 may also include a storage device 524. Examples of a storage device (e.g., storage device 524) include, but are not limited to, a hard disk drive for reading from and/or writing to a hard disk, a magnetic disk drive for reading from and/or writing to a removable magnetic disk, an optical disk drive for reading from and/or writing to an optical medium (e.g., a CD, a DVD, etc.), a solid-state memory device, and any combinations thereof. Storage device 524 may be connected to bus 512 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 524 (or one or more components thereof) may be removably interfaced with computer system 500 (e.g., via an external port connector (not shown)). Particularly, storage device 524 and an associated machine-readable medium 528 may provide nonvolatile and/or volatile storage of machine-readable instructions, data structures, program modules, and/or other data for computer system 500. In one example, software 520 may reside, completely or partially, within machine-readable medium 528. In another example, software 520 may reside, completely or partially, within processor 504.

Computer system 500 may also include an input device 532. In one example, a user of computer system 500 may enter commands and/or other information into computer system 500 via input device 532. Examples of an input device 532 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 532 may be interfaced to bus 512 via any of a variety of interfaces (not shown) including, but not limited to, a serial interface, a parallel interface, a game port, a USB interface, a FIREWIRE interface, a direct interface to bus 512, and any combinations thereof. Input device 532 may include a touch screen interface that may be a part of or separate from display 536, discussed further below. Input device 532 may be utilized as a user selection device for selecting one or more graphical representations in a graphical interface as described above. Input device 532 may also include sensors 104, which provides the AE data and thermodynamic entropy data discussed above. The output of sensors 104 can be stored, for example, in storage device 524 and can be further processed to provide, for example, analysis of the clamp force value over time, by processor 504.

A user may also input commands and/or other information to computer system 500 via storage device 524 (e.g., a removable disk drive, a flash drive, etc.) and/or network interface device 540. A network interface device, such as network interface device 540 may be utilized for connecting computer system 500 to one or more of a variety of networks, such as network 544, and one or more remote devices 548 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 544, may employ a wired and/or a wireless mode of communication. In general, any network topology may be used. Information (e.g., data, software 520, etc.) may be communicated to and/or from computer system 500 via network interface device 540.

Computer system 500 may further include a video display adapter 552 for communicating a displayable image to a display device, such as display device 536. Examples of a display device include, but are not limited to, a liquid crystal display (LCD), a cathode ray tube (CRT), a plasma display, a light emitting diode (LED) display, and any combinations thereof. Display adapter 552 and display device 536 may be utilized in combination with processor 504 to provide a graphical representation of a utility resource, a location of a land parcel, and/or a location of an easement to a user. In addition to a display device, a computer system 500 may include one or more other peripheral output devices including, but not limited to, an audio speaker, a printer, and any combinations thereof. Such peripheral output devices may be connected to bus 512 via a peripheral interface 556. Examples of a peripheral interface include, but are not limited to, a serial port, a USB connection, a FIREWIRE connection, a parallel connection, and any combinations thereof

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A monitoring system for determining the remaining useful life of a component under cyclic stress, the monitoring system comprising:
a first sensor measuring a first signal including a first data representative of crack propagation;
a second sensor measuring a second signal including a second data representative of acoustic emissions;
a processor in electronic communication with said first sensor and said second sensor and receiving said first data and said second data, said processor determining from said second data at least one condition indicator, and wherein said processor determines, based upon said at least one condition indicator and said first data, the remaining useful life of the component.

2. A monitoring system according to claim 1, wherein said second data is demodulated.

3. A monitoring system according to claim 2, wherein said second data is demodulated by an analog circuit.

4. A monitoring system according to claim 3, wherein said second data is demodulated by an analog Hilbert transform circuit.

5. A monitoring system according to claim 1, wherein an envelope associated with said second data is determined without a microcontroller or digital signal processing unit.

6. A monitoring system according to claim 1, wherein an acoustic emission event is determined from said second data set.

7. A monitoring system according to claim 6, wherein said processor removes a white noise data from said second data.

8. A monitoring system according to claim 6, wherein, based upon said acoustic emission event, said processor determines at least one of a magnitude of the acoustic emission event, a cumulative number of acoustic emission events, an operational time from a last acoustic emission event.

9. A monitoring system according to claim 1, wherein a cumulative fault model is developed from said at least one condition indicator.

10. A monitoring system according to claim 1, wherein the remaining useful life of the component is determined by the equation:
$$1 / D ( 4 {σ}^{2} π ) ( ln ( {a}_{f} ) - ln ( {a}_{o} ) )$$
where:
D is estimated as (da/dN)/(4σ²πa);
a_{f} is determined statically or based on an allowable crack length of the component;
a₀ is the current measured crack; and
σ² is determined by using a recursive estimate.

11. A monitoring system according to claim 1, wherein said second data is a linear dynamic system with Gaussian noise, and wherein a Kalman filter is used to develop an state prediction.

12. A monitoring system for determining the remaining useful life of a component of a rotorcraft or fix-wing aircraft comprising:
a first sensor measuring a first signal including a first data representative of crack propagation;
a second sensor measuring a second signal including a second data representative of acoustic emissions;
a processor in electronic communication with said first sensor and said second sensor and receiving said first data and said second data, said processor including a set of instructions for removing a white noise data from said second data so as to determine the presence of an acoustic emission.

13. A monitoring system according to claim 1, wherein said set of instructions further include determining from said second data at least one condition indicator, and determining, based upon said at least on condition indicator and said first data, the remaining useful life of the component.

14. A monitoring system according to claim 12, wherein said second data is demodulated by an analog circuit.

15. A monitoring system according to claim 14, wherein said second data is demodulated by an analog Hilbert transform circuit.

16. A monitoring system according to claim 12, wherein the remaining useful life of the component is determined by the equation:
$$1 / D ( 4 {σ}^{2} π ) ( ln ( {a}_{f} ) - ln ( {a}_{o} ) )$$
where:
D is estimated as (da/dN)/(4σ²πa);
a_{f} is determined statically or based on an allowable crack length of the component;
a₀ is the current measured crack; and
σ² is determined by using a recursive estimate.

17. A method of determining the remaining useful life of a component under cyclic stress comprising:
receiving, as an input, a first signal including a first data representative of crack propagation;
receiving, as an input, a second signal including a second data representative of acoustic emissions;
determining an acoustic emission envelope from the second data;
removing a white noise data from the second data;
determining a condition indicator from the second data;
developing a cumulative fault model from the first data and the second data; and
determining the remaining useful life based upon the first data, the condition indicator, and the cumulative fault model.

18. A method according to claim 17, further including demodulating the second data.

19. A method according to claim 18, wherein said demodulating is completed by an analog Hilbert transform circuit.

20. A method according to claim 17, wherein the condition indicator is proportional to a crack length in the component.
